(19) United States
(12) Patent Application Publication
(10) Pub. No.: US 2019/0074793 A1
(43) Pub. Date: Mar. 7, 2019

(54) CLEANING APPARATUS AND PV MODULE CLEANING SYSTEM

(71) Applicant: HANGZHOU PINNET TECHNOLOGIES CO., LTD., Hangzhou (CN)

(72) Inventors: Wenyong CHEN, Hangzhou (CN); Sibo ZHAO, Hangzhou (CN); Long WANG, Hangzhou (CN); Zhongtang LIANG, Hangzhou (CN); Bangyou JIANG, Hangzhou (CN); Lin MA, Hangzhou (CN); Wenping ZHU, Hangzhou (CN)

(73) Assignee: HANGZHOU PINNET TECHNOLOGIES CO., LTD., Hangzhou (CN)

(21) Appl. No.: 15/741,507

(22) PCT Filed: Nov. 11, 2016
(86) PCT No.: PCT/CN2016/105532

§ 371 Date: Jan. 3, 2018

(51) Int. Cl. H02S 40/10; B08B 1/00; B08B 11/04

(52) U.S. Cl. CPC H02S 40/10; B08B 13/00; B08B 11/04; B08B 1/001

(57) ABSTRACT

The present invention discloses cleaning apparatus and a PV module cleaning system. The cleaning apparatus includes a sweeper, a mobile terminal, a guiding rail and a control system. The mobile terminal is used for bearing the sweeper and walks along the guiding rail under the control of the control system, and the sweeper can move on the mobile terminal under the control of the control system; and the PV module cleaning system includes PV array panels, the PV array panels are m*n matrix, both m and n are positive integers, the guiding rail is located at one side of the PV array panels, the mobile terminal is located above the guiding rail, the sweeper is loaded on the bearing frame of the mobile terminal, and the sweeper reciprocates on the PV array panels through a walking mechanism.

### BACKGROUND OF THE INVENTION

### Field of the Invention

The present invention relates to a photovoltaic (PV) power station cleaning apparatus and, more particularly, to a cleaning apparatus and a PV module cleaning system.

### Description of the Related Art

The main power generation apparatus of a solar photovoltaic (PV) power station is a solar photovoltaic panel, and the power generation of the solar photovoltaic panel depends on the intensity of incident sunlight. However, the PV array panels are installed in the open air. The sand, dust and industrial pollutants in the natural cover the surface of the solar panel, which affects the absorption of the light to a great extent. According to statistics, the loss can account for 5%-8% of the total solar power generation, or even more. Therefore, it is necessary to often carry out a dust cleaning for the surface of the solar panel at an appropriate time to reduce dust accumulation and improve the benefit of the power station. Generally, the area of the photovoltaic power station is large, and currently most of them use manual cleaning with low efficiency, long cycle, and high cost. Therefore, the design of efficient and automated cleaning apparatus will be of great practical value, and will have important significance for the development of the industry.

### BRIEF SUMMARY OF THE INVENTION

To overcome the shortcomings of the prior art, the present invention provides a cleaning apparatus and a photovoltaic (PV) module cleaning system.

To achieve the above objectives, the technical solution adopted by the present invention is to provide a cleaning apparatus, including:

a sweeper;

a mobile terminal for bearing the sweeper, movably connected with the sweeper;

a guiding rail, slidably connected with the mobile terminal; and

a control system, configured to control a movement of the sweeper and the mobile terminal.

In one embodiment of the present invention, the control system may include a power supply device and a control wire reel. The power supply device may be a trolley conductor, and the control wire reel may be fixed on the mobile terminal. The control wire reel may be wound with a cable. One end of the cable may be communicated with an electricity-out end of the trolley conductor, and the other end of the cable may be electrically connected with the sweeper.

In one embodiment of the present invention, the control wire reel may include a electrical control device, and the electrical control device may have an electrical signal connection with the sweeping drive device. The electrical control device controls the retraction and extension of the cable according to the speed and displacement of the sweeper.

In one embodiment of the present invention, the sweeper may include: a body frame, a sweeping head, a sweeping drive device and a mobile foot. The sweeping head, the sweeping drive device and the mobile foot may all be fixed on the body frame, the mobile foot may be electrically connected with the sweeping drive device, and the sweeping drive device may be electrically connected with the control wire reel. The sweeping drive device drives the mobile foot to move.

In one embodiment of the present invention, the mobile terminal may include: a loading frame, a first drive device and a first walking mechanism. Both the first drive device and the first walking mechanism may be fixedly connected with the loading frame, and the first drive device may be electrically connected with the power supply device. The first walking mechanism may be electrically connected with the first drive device, and the first walking mechanism may be slidably connected with the guiding rail.

In one embodiment of the present invention, the control system may further include a limiting switch. The limiting switch may be fixedly installed on the mobile terminal, and the limiting switch may be electrically connected with the first drive device for controlling an operation of the first drive device; the limiting switch may be electrically connected with the sweeping drive device for controlling an operation of the sweeping drive device.

In one embodiment of the present invention, the first walking mechanism may include a walking wheel and a side wheel. Both the walking wheel and the side wheel may be contacted and slidably connected with a surface of the guiding rail, the walking wheel may have a transmission connection with the first drive device, the walking wheel may be located above the guiding rail, the walking wheel may be fixedly connected with the loading frame through a U-shaped support, and the walking wheel may be connected by a U-shaped support bearing; and the side wheel may be located at both sides of the guiding rail, the side wheel may be fixedly connected with the loading frame through a connection frame, and the side wheel may be rotatably connected with the connection frame.

A PV module cleaning system includes PV array panels. The PV array panels are m*n matrix, and both m and n are positive integers. The guiding rail is located at one side of the PV array panels, and the mobile terminal is located above the guiding rail. The sweeper is loaded on the bearing frame of the mobile terminal. An inclination angle of the bearing frame is the same as an inclination angle of the PV array panels, and the sweeper reciprocates on the PV array panels through a walking mechanism.

In one embodiment of the present invention, a height of the sweeper may be greater than a height of the PV array panels, and the walking mechanism may move along an edge of the PV array panels.

The present invention has following beneficial effects:

The cleaning apparatus of the present invention includes a sweeper, a mobile terminal, a guiding rail and a control system. The structure of the device is simple and compact, the cost is low, and the application is wide. The sweeper is loaded on the mobile terminal. The mobile terminal stops at a suitable position on the guiding rail under the control of the limiting device, and then the sweeper walks on the PV array panels under the control of the control system to achieve the cleaning to the photovoltaic panels.

Further, when the sweeper moves to the other end of the PV array panels, by sending signals to the sweeper by the limiting switch, the sweeper returns to the mobile terminal along the PV array panels. At this moment, the limiting switch on the mobile terminal is triggered, and the signal is sent to the first drive apparatus of the mobile terminal, such that the mobile terminal moves along the guiding rail toward a heading direction under the action of the first walking mechanism. When the mobile terminal walks to the next PV array panel to be cleaned, it stops at a suitable position through the limiting switch to carry out cleaning of the above round trip action for the corresponding PV array panels.

Through constant repetition of the above cleaning actions, the efficient and automatic cleaning of photovoltaic power stations is achieved, which saves labor costs, improves work efficiency, increases power generation, thereby obtaining economic and ecological benefits.

### BRIEF DESCRIPTION OF THE DRAWINGS

FIG. 1 is a stereogram of a cleaning apparatus of the present invention;

FIG. 2 is a front view of FIG. 1 of the present invention;

FIG. 3 is a left view of FIG. 1 of the present invention; and

FIG. 4 is a structure schematic diagram of a photovoltaic (PV) module cleaning system of the present invention.

1 sweeper; 2 mobile terminal; 3 guiding rail; 200 loading frame; 4 clamping block; 500 PV array panels; 21 first motor; 22 reduction gearbox; 23 U-shaped support; 24 walking wheel; 25 connection frame; 26 side wheel; 27 U-shaped groove; 41 trolley conductor; 42 winding disc; 44 cable; 100 body frame; 12 sweeping drive device; and 14 guiding wheel.

### DETAILED DESCRIPTION OF THE INVENTION

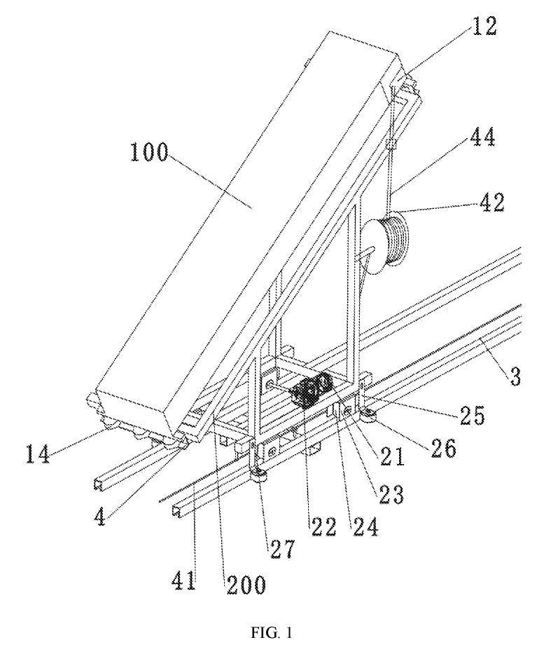

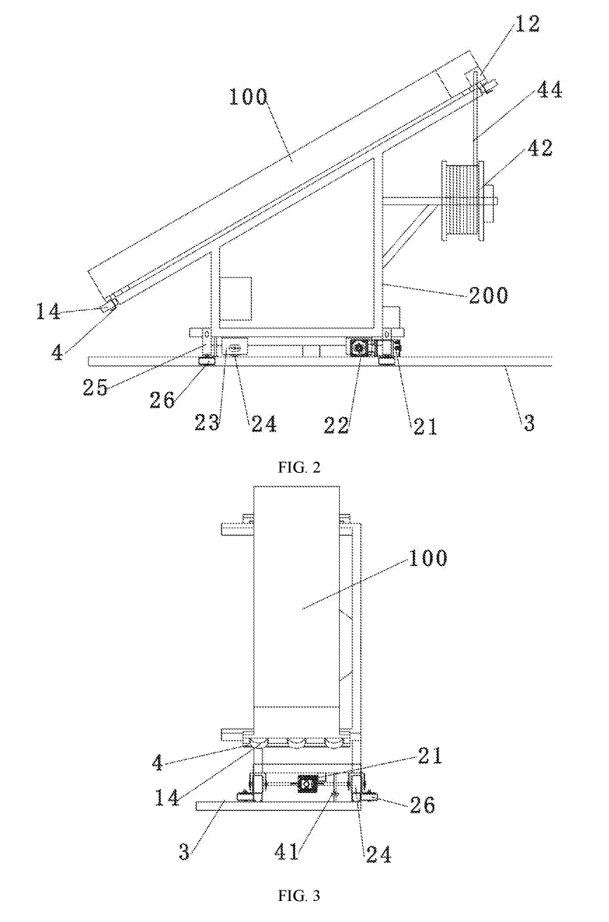

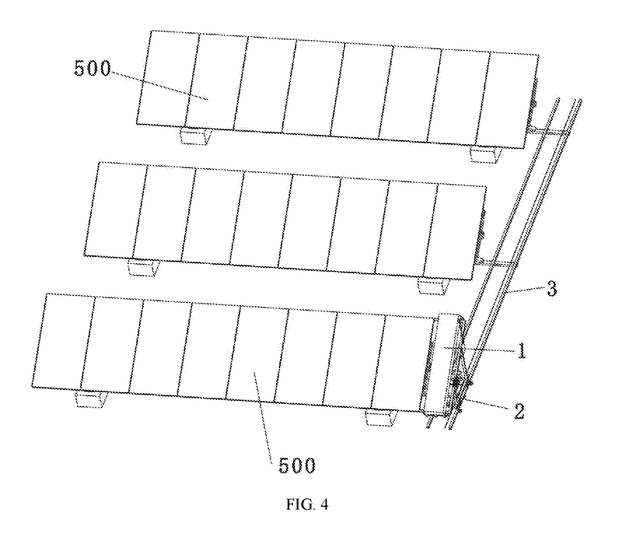

The present invention will be further described combining with the embodiments and the accompanying drawings FIG. 1 to FIG. 4.

### Embodiment 1

The technical solution adopted by the present invention is cleaning apparatus, including: a sweeper 1, a mobile terminal 2, a guiding rail 3, and a control system. The mobile terminal 2 is used for bearing the sweeper 1 and walks along the guiding rail 3 under the control of the control system, and the sweeper 1 can move on the mobile terminal 2 under the control of the control system.

The mobile terminal 2 includes a loading frame 200, a first drive device, and a first walking mechanism. The sweeper 1 is placed on the loading frame 200 firmly. The loading frame 200 has a certain inclination angle, and the inclination angle is consistent with photovoltaic (PV) array panels 500. The sweeper 1 can be clamped on the loading frame 200 by a clamping block 4. The first drive device includes a transmission-connected first motor 21 and a reduction gearbox 22. During working, the first motor 21 drives the reduction gearbox 22 after being powered on, and the reduction gearbox 22 then drives the first walking mechanism to move on the guiding rail 3. In the present embodiment, the first walking mechanism includes a U-shaped support 23, a walking wheel 24, a connection frame 25 and side wheel 26. Both the U-shaped support 23 and the connection frame 25 are fixedly installed on the loading frame 200, and the walking wheel 24 is connected with a U-shaped support bearing. The walking wheel 24 is located in a U-shaped groove 27 of the U-shaped support 23, and the U-shaped support 23 at the bottom of the U-shaped groove 27 plays a role of supporting the loading frame 200. The walking wheel 24 is located above the guiding rail 3 and rolls along the guiding rail 3. The side wheel 26 is rotatably connected with the connection frame 25, and the side wheel 26 is close to the outside surface of the guiding rail 3. The side wheel 26 plays a role of guiding to prevent the mobile terminal 1 from deviating during moving.

The control system includes a power supply device, a control wire reel and a limiting switch. The power supply device is a trolley conductor 41, and the trolley conductor 41 is disposed beside the guiding rail 3 along the direction in which the guiding rail 3 extends. The control wire reel is fixed on the loading frame 200 of the mobile terminal 2. The control wire reel includes an electrical control device and a winding disc 42, and the electrical control device is fixedly connected with the winding disc 42. The winding disc 42 is wound with a cable 44, one end of the cable 44 is communicated with an electricity-out end of the trolley conductor 41, and the other end of the cable 44 is electrically connected with the sweeper 1. That is, the power supply of the sweeper 1 comes from the cable 44 wound on the control wire reel, and the cable 44 is automatically dropped from the winding disc 42 as the sweeper 1 moves, thereby ensuring that the sweeper 1 can be effectively power supplied when the sweeper 1 is away from the mobile terminal 2. The intelligent retraction and extension of the cable 44 is realized by the electrical control device controlling the rotation of the winding disc 42 according to the speed and displacement of the sweeper 1. The limiting switch includes at least a first limiting switch and a second limiting switch, and the limiting switch can be fixedly installed on the loading frame 200; and the first limiting switch is used for controlling the operation of the first drive device, and the second limiting switch is electrically connected with the sweeping drive device for controlling the operation of the sweeping drive device. The limiting switch may be an infrared sensor limiting switch for determining the position relationship between the sweeper 1 and the loading frame 200 and the position of the mobile terminal 2 on the guiding rail 3, thereby realizing the control to the sweeper 1 and the mobile terminal 2.

The sweeper in the present embodiment includes a body frame 100, a sweeping head, a sweeping drive device 12 and a mobile foot. The sweeping head 11, the sweeping drive device 12 and the mobile foot are all fixed on the body frame 100. The sweeping drive device 12 is electrically connected with the cable 44 to achieve power supply for the sweeping drive device 12. The sweeping drive device 12 drives the mobile foot to slide with respect to the PV array panels 500.

The mobile foot includes a walking wheel and a guiding wheel 44, the guiding wheel 14 is used to guide the direction of walking, and the walking wheel is used to roll along the PV array panels 500. Further, the sweeping head also carries out actions through transmission components fixed on the body frame 100, to achieve cleaning work to dust and so on. The sweeping head can be a brush, a drapery, or other structures which can achieve the cleaning object.

### Embodiment 2

A PV module cleaning system using the cleaning apparatus in embodiment 1, the PV array panels are a m*n matrix, and both m and n are positive integers. FIG. 4 describes a matrix of m=1 and n=3. During working, the guiding rail 3 is disposed at one side of the PV array panels 500, the mobile terminal 2 is disposed above the guiding rail 3, and the sweeper 1 is loaded on the bearing frame 200 of the mobile terminal 2. The inclination angle of the bearing frame 200 is substantially consistent with the inclination angle of the PV array panels 500, so as to be cleaner for cleaning and not to hinder the operation of the sweeper. The inclination angle allows a certain tolerance, when the angular tolerance exists, the height of the sweeper 1 should be adjusted properly by adjusting the height of the bearing frame 200 properly to ensure the operation is not hindered. The sweeper 1 is on the upper surface of the PV array panels 500, and the cleaning head 10 is just close to the “fugitive dust” surface of the PV array panels 500. The walking mechanism is disposed at the edge along the photovoltaic panel 500, and the advancing wheel 13 rolls along the edge during working to sweep the dust on the surface of the “fugitive dust”. The sweeper reciprocates on the PV array panels through a walking mechanism.

The repeated cleaning action of the present invention is generally “mobile terminal selects place for anchorage-sweeping head reciprocates for cleaning action-mobile terminal moves to the next anchorage-sweeping head reciprocates for cleaning action”. That is, when the sweeper 1 finishes cleaning the cleaning work of the former PV array panels 500 and returns to the bearing frame 200, the mobile terminal 2 receives the electrical signal from the second limiting switch and begins to walk along the guiding rail 3 to the next anchorage. When it walks to an appropriate position, it stops moving under the control of the first limiting switch. At this moment, the sweeper 1 acquires the wireless signal from the first limiting switch, starts to move from the mobile terminal to the PV array panels 500, walks along the PV array panels 500, and sweeps the surface through the cleaning head simultaneously. When the sweeper 1 moves to the other end of the PV array panels 500, the signal is sent to the sweeping drive device through the second limiting switch, and the sweeping drive device drives the sweeper to reversely walk along the PV array panels 500 to return back to the bearing frame 200 of the mobile terminal 2. At this time, the second limiting switch on the mobile terminal 2 is triggered and signal is sent to the first drive device, the first drive device is activated. The first walking mechanism is driven to move along the guiding rail to the next anchorage, that is, the mobile terminal loading the sweeper moves to the next PV array panels. Repeat above actions.

The present invention designs a completely new mode of PV module cleaning system. The structure is simple and compact, and the application is wide. A sweeper can sweep a plurality of PV array panels. The efficiency is high, the automation degree is high, the labor costs are saved, the dust accumulation can be timely removed at the same time, and the effect of dust accumulation to the photovoltaic power station power generation can be maximally removed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. Cleaning apparatus, comprising:
a sweeper;
a mobile terminal for bearing the sweeper, movably connected with the sweeper;
a guiding rail, slidably connected with the mobile terminal; and
a control system, configured to control a movement of the sweeper and the mobile terminal.

2. The cleaning apparatus according to claim 1, the control system comprising a power supply device and a control wire reel, the power supply device being a trolley conductor, wherein the control wire reel is fixed on the mobile terminal, the control wire reel is wound with a cable, one end of the cable is communicated with an electricity-out end of the trolley conductor, and the other end of the cable is electrically connected with the sweeper.

3. The cleaning apparatus according to claim 2, wherein the control wire reel comprises a electrical control device, and the electrical control device has an electrical signal connection with the sweeping drive device.

4. The cleaning apparatus according to claim 2, the sweeper comprising: a body frame, a sweeping head, a sweeping drive device and a mobile foot, the sweeping head, wherein the sweeping drive device and the mobile foot are all fixed on the body frame, the mobile foot is electrically connected with the sweeping drive device, and the sweeping drive device is electrically connected with the control wire reel.

5. The cleaning apparatus according to claim 2, the mobile terminal comprising: a loading frame, a first drive device and a first walking mechanism, wherein both the first drive device and the first walking mechanism are fixedly connected with the loading frame, the first drive device is electrically connected with the power supply device, the first walking mechanism is electrically connected with the first drive device, and the first walking mechanism is slidably connected with the guiding rail.

6. The cleaning apparatus according to claim 5, the control system further comprising a limiting switch, wherein the limiting switch is fixedly installed on the mobile terminal, the limiting switch is electrically connected with the first drive device for controlling an operation of the first drive device, and the limiting switch is electrically connected with the sweeping drive device for controlling an operation of the sweeping drive device.

7. The cleaning apparatus according to claim 5, the first walking mechanism comprising a walking wheel and a side wheel, wherein the walking wheel and the side wheels are both contacted and slidably connected with a surface of the guiding rail, the walking wheel has a transmission connection with the first drive device, the walking wheel is located above the guiding rail, the walking wheel is fixedly connected with the loading frame through a U-shaped support, and the walking wheel is connected by a U-shaped support bearing; and a plurality of side wheels are located at both sides of the guiding rail, the side wheel is fixedly connected with the loading frame through a connection frame, and the side wheel is rotatably connected with the connection frame.

8. A PV module cleaning system using the cleaning apparatus as claimed in claim 1, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.

9. The cleaning system according to claim 8, wherein a height of the sweeper is greater than a height of the PV array panels, and the walking mechanism moves along an edge of the PV array panels.

10. The cleaning apparatus according to claim 3, the mobile terminal comprising: a loading frame, a first drive device and a first walking mechanism, wherein both the first drive device and the first walking mechanism are fixedly connected with the loading frame, the first drive device is electrically connected with the power supply device, the first walking mechanism is electrically connected with the first drive device, and the first walking mechanism is slidably connected with the guiding rail.

11. The cleaning apparatus according to claim 4, the mobile terminal comprising: a loading frame, a first drive device and a first walking mechanism, wherein both the first drive device and the first walking mechanism are fixedly connected with the loading frame, the first drive device is electrically connected with the power supply device, the first walking mechanism is electrically connected with the first drive device, and the first walking mechanism is slidably connected with the guiding rail.

12. The cleaning apparatus according to claim 10, the control system further comprising a limiting switch, wherein the limiting switch is fixedly installed on the mobile terminal, the limiting switch is electrically connected with the first drive device for controlling an operation of the first drive device, and the limiting switch is electrically connected with the sweeping drive device for controlling an operation of the sweeping drive device.

13. The cleaning apparatus according to claim 11, the control system further comprising a limiting switch, wherein the limiting switch is fixedly installed on the mobile terminal, the limiting switch is electrically connected with the first drive device for controlling an operation of the first drive device, and the limiting switch is electrically connected with the sweeping drive device for controlling an operation of the sweeping drive device.

14. The cleaning apparatus according to claim 10, the first walking mechanism comprising a walking wheel and a side wheel, wherein the walking wheel and the side wheels are both contacted and slidably connected with a surface of the guiding rail, the walking wheel has a transmission connection with the first drive device, the walking wheel is located above the guiding rail, the walking wheel is fixedly connected with the loading frame through a U-shaped support, and the walking wheel is connected by a U-shaped support bearing; and a plurality of side wheels are located at both sides of the guiding rail, the side wheel is fixedly connected with the loading frame through a connection frame, and the side wheel is rotatably connected with the connection frame.

15. The cleaning apparatus according to claim 11, the first walking mechanism comprising a walking wheel and a side wheel, wherein the walking wheel and the side wheels are both contacted and slidably connected with a surface of the guiding rail, the walking wheel has a transmission connection with the first drive device, the walking wheel is located above the guiding rail, the walking wheel is fixedly connected with the loading frame through a U-shaped support, and the walking wheel is connected by a U-shaped support bearing; and a plurality of side wheels are located at both sides of the guiding rail, the side wheel is fixedly connected with the loading frame through a connection frame, and the side wheel is rotatably connected with the connection frame.

16. A PV module cleaning system using the cleaning apparatus as claimed in claim 2, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.

17. A PV module cleaning system using the cleaning apparatus as claimed in claim 3, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.

18. A PV module cleaning system using the cleaning apparatus as claimed in claim 4, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.

19. A PV module cleaning system using the cleaning apparatus as claimed in claim 5, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.

20. A PV module cleaning system using the cleaning apparatus as claimed in claim 6, comprising PV array panels, the PV array panels being m*n matrix, both m and n being positive integers, wherein the guiding rail is located at one side of the PV array panels, the mobile terminal is located above the guiding rail, the sweeper is loaded on a bearing frame of the mobile terminal, an inclination angle of the bearing frame is the same as an inclination angle of the PV array panels, and the sweeper reciprocates on the PV array panels through a walking mechanism.
